(19) United States
(12) Patent Application Publication
(10) Pub. No.: US 2008/0148037 A1
(43) Pub. Date: Jun. 19, 2008

(54) Efficient platform initialization

(76) Inventors: Michael A. Rothman, Puyallup, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/640,055

(22) Filed: Dec. 15, 2006

(51) Int. Cl. G06F 9/00

(52) U.S. Cl. 713/2

(57) ABSTRACT

A processor includes non-volatile memory in which platform state is saved in order to record the hardware resources present in the platform. The platform state information may be received by an out-of-band means, such as that provided to a secondary processor of a management engine. Rather than querying the individual hardware resources during the boot process in order to detect their presence on the platform, a saved platform state is queried in the non-volatile memory. In this manner, detection of resources may be streamlined. For at least one alternative embodiment, initialization of resources may be streamlined during the boot process by performing initialization of some hardware resources by a first processor while a secondary processor concurrently performs initialization of others of the hardware resources. Other embodiments are also described and claimed.

### BACKGROUND

1. Technical Field

The present disclosure relates generally to information processing systems and, more specifically, to efficient boot processing for computer systems.

2. Background Art

Before a computer system can operate, it must have an operating system (OS) in its memory that allows the computer's resources to be reached and controlled by the other software, such as the various application programs. Loading of this operating system is performed during initialization processing, referred to as “boot” processing, that is performed when a system experiences a power cycle or warm start event. It is desirable, especially in high performance computing (HPC) environments, that the system complete its boot processing as quickly as possible.

A computer system includes a basic input/output system (BIOS) memory that stores the code for the boot sequence the central processing unit (CPU) executes to detect, apply power to, and initialize the computer components. Typically, the CPU executing the BIOS code initializes certain hardware components, such as the memory, and then serially detects and initializes other hardware devices of the system, including peripheral component interconnect (PCI) devices, hard disk drives, PS/2 keyboard devices, and the like. The time taken to boot the system increases as the number of hardware devices to be initialized increases.

The time needed to boot a system is generally preferred to be as short as possible by most users of computing systems. Indeed, in some situations it is required that a system be able to boot up within a specific amount of time. For example, mission critical systems have certain requirements, such as maintaining 99.999% availability, also known as the “five nines”. For instance, to comply with the “five nines” requirement over the course of a year, boot time could not take more than 5.25 minutes, i.e., 365 days*24 hours*60 minutes*0.00001 (the downtime allowed per year for a re-boot). Meeting this requirement can be a challenge, particularly for systems that include a large number of hardware components, especially when one considers the generally serial manner in which the hardware components of many common platforms are initialized during boot processing.

### BRIEF DESCRIPTION OF THE DRAWINGS

Embodiments of the present invention may be understood with reference to the following drawings in which like elements are indicated by like numbers. These drawings are not intended to be limiting but are instead provided to illustrate selected embodiments of systems, methods and mechanisms to efficiently initialize a platform via the use of stored platform state.

FIG. 1 is a flowchart illustrating at least one embodiment of a method 100 for efficiently detecting the hardware resources of a platform via the use of stored platform state so that the hardware itself need not be queried.

FIG. 2 is a flowchart illustrating at least one embodiment of a method for utilizing a secondary processor to increase the efficiency of hardware initialization processing during a boot process.

FIG. 3 is a block diagram of a multiprocessor system in accordance with an embodiment of the present invention that includes multi-drop bus communication pathways.

FIG. 4 is a block diagram of a multiprocessor system in accordance with an embodiment of the present invention that includes point-to-point interconnects.

FIG. 5 is a timing diagram illustrating efficiency to be gained from a method, such as that of FIG. 1, for utilizing stored platform state to detect platform hardware resources.

FIG. 6 is a timing diagram illustrating efficiency to be gained from a method, such as that of FIG. 2, for offloading to a secondary processor the initialization of platform hardware resources.

FIG. 7 is a flowchart illustrating at least one embodiment of a method for offloading initialization processing to a secondary processor.

### DETAILED DESCRIPTION

The following discussion describes selected embodiments of methods, systems and mechanisms to efficiently initialize a platform through the use of saves platform state. The apparatus, system and method embodiments described herein may be utilized with single-core or multi-core systems. In the following description, numerous specific details such as processor types, boot processing, system configurations, and particular order of operations for method processing have been set forth to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring the present invention.

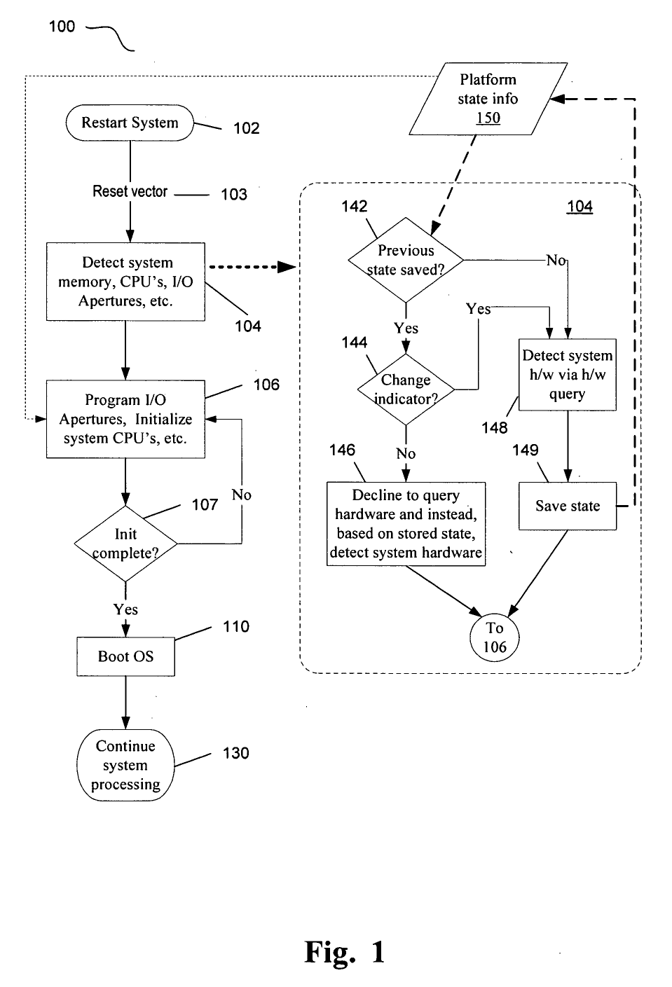

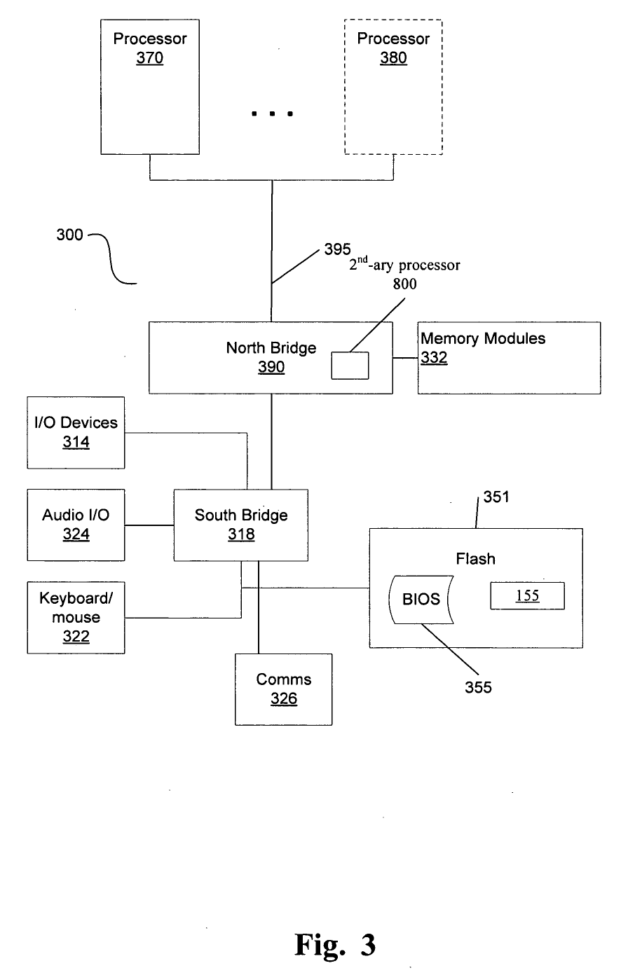

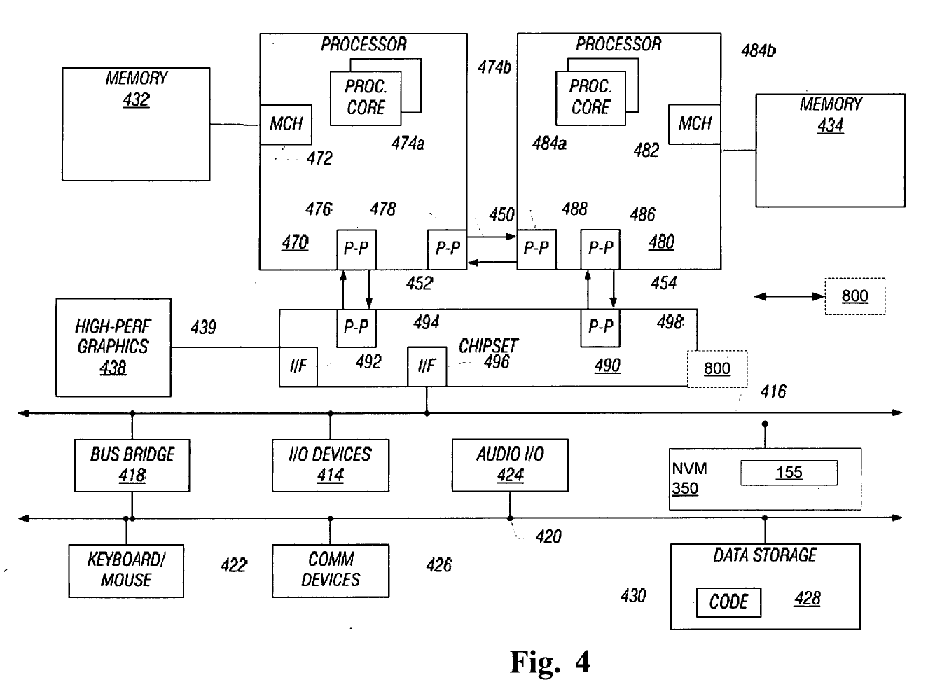

FIG. 1 is a flowchart illustrating at least one embodiment of a method 100 for efficiently detecting the hardware resources of a platform by querying a saved platform state rather than querying the hardware to detect the presence of each of the hardware resources. The method may be performed, for at least one embodiment, by a processing system 300, 400 such as embodiments of those illustrated in FIGS. 3 and 4.

FIG. 1 illustrates that processing for the method 100 begins at block 102, where the computer system is restarted. That is, in many common processing systems, the boot process is started with a restart function of some kind. This might be a cold restart (power to the hardware is initially off), a warm restart (the hardware is already powered up), or one of several other starting conditions. A transition out of sleep or hibernate states may be a warm restart.

The reset function typically resets hardware to a known state and generates a reset interrupt, which vectors the system to a program in non-volatile memory and begins execution from that point.

FIG. 1 illustrates that the reset vector 103 is dispatched responsive to the system reset event 102. The reset vector 103 causes a Basic Input-Output System (BIOS) program (typically stored in flash memory) to be invoked at block 104.

The BIOS program is initiated at block 104; the BIOS program enables basic input-output (IO) control. Typically, the BIOS has no information about the environment required by the operating system and therefore can do nothing to initialize the system beyond putting the hardware into a known state.

At block 104, the BIOS code performs typical start-up functions such as detecting memory, detecting all system CPU's, and detecting I/O apertures.

Regarding the detection of CPU's, for at least one embodiment the method 100 is performed on a chip multiprocessor (CMP) system that includes a plurality of CPU's. Each of these CPU's is detected at block 104. If the method 100 is instead performed for a system having a single CPU, the single CPU is detected at block 104.

Regarding I/O apertures, such as PCI devices, the apertures may be enumerated by querying each of the devices to determine its device ID, Vendor ID and other information, such as the address ranges required for boot and/or talking to a device.

FIG. 1 illustrates that the detection 104 of system hardware components may be performed in a manner that allows detection of hardware resources without requiring probing the hardware, as is illustrated within the broken-line box in FIG. 1.

FIG. 1 illustrates that the method 104 determines at block 142 whether platform state information 150 regarding platform hardware components is available. That is, the query at block 142 determines whether platform state information is available from an alternative source, such that probing of the hardware is not required in order to detect hardware components of the system. For at least one embodiment, such information may be available by an out-of-band means, such as out-of-band input by a system administrator. This out-of-band means may be supported by a system (such as system 300 and system 400 illustrated in FIGS. 3 and 4, respectively) that incorporate Intel® Active Management Technology to allow out-of-band communications with a secondary processor (see, e.g., processor 800 in the north bridge 390 of FIG. 3 and in the chipset 490 or on the point-to-point interconnect fabric of FIG. 4). For such embodiments, the secondary processor may be part of a management engine, which may also include firmware or software that is executed by the secondary processor in order to achieve the functionality of the management engine.

For at least one other embodiment, the platform information 150 may be available as previously-stored information determined during a previous boot sequence. For at least one embodiment, such information regarding the previous platform state may be stored in non-volatile memory. (See, e.g., Flash memory 351 of FIG. 3 and NVM 350 of FIG. 4).

If the platform state information 150 is available (e.g., it has been previously stored, or it is available via out-of-band administrator input, or is available via some other means, such as local override) then the current boot process may be made more efficient by utilizing the stored information to detect the presence of hardware components of the system, rather than performing a hardware probe to determine each component.

For a local override situation, the stored platform state is ignored and, instead, the user directs that an alternate set of state data from some other location be used. A local override may be performed, for example, when it is desired that the current boot process be made more efficient according to the present teachings, but the user for some reason wants to avoid using stored platform state information. This may occur, for instance, due to suspicion that the stored platform state information might be faulty in some way or because the user wants the machine to behave in a certain predetermined way during its initialization without interrogating the underlying hardware.

For the particular embodiment of hardware resource detection 104 illustrated in FIG. 1, it is assumed that previous platform state information 150 is available in a non-volatile storage device, although one of skill in the art will recognize that the embodiment 104 may be modified to accommodate other manners of providing platform state information 150 (e.g., out-of-band inputs or local override).

Accordingly, if it is determined at block 142 that platform state information is available, then processing proceeds to block 144. Otherwise, processing proceeds to block 148, where the hardware is queried, in a traditional fashion, to detect CPU's, memory, and other hardware components of the platform, such as keyboards, mouse, hard disk drives, and the like.

Block 144 is performed if a previous platform state has been stored in non-volatile memory. For such embodiment, it is determined at block 144 whether conditions exist that may indicate that the saved platform state could be stale. One manner of determining that stored platform state information may be stale is to query a change indicator. A change indicator may be, for example, a chassis intrusion indicator that may be set by the platform when a sensor detects that the case or chassis of the computing system has been opened. If the chassis intrusion indicator signals that the chassis of the computing system has been opened, it is possible that a hardware component has been added to or removed from the system.

Accordingly, if the change indicator is determined, at block 144, to indicate that the current platform configuration may have recently changed, then the saved platform state may therefore be outdated, and processing proceeds to block 148. At block 148, a traditional hardware probe is performed in order to detect or enumerate the hardware components of the system. After the current platform state has been detected, the platform state is saved to the NVM store 150 at block 149. This storage 149 of the current platform state is performed in order that the next boot process may be performed more efficiently (see, e.g., block 142).

It should be noted that, at block 148, alternative embodiments may perform only a subset of the traditional hardware probing. That is, depending on the granularity of change indicated by the change indicator, it may be that only certain hardware portions of the system need to be probed. For example, for an embodiment, where multiple change indicators are used to indicate whether specific portions of the system may have changed, traditional enumeration processing need only be performed for those portions of the system that may have changed. For such embodiment, for example, there may be a specific change indicator to indicate whether memory has changed. If such indicator is not determined, at block 144, to be set, then there is no need to perform a hardware query to detect the memory module(s).

If it is determined at block 144 that no change indicators are set, then it is assumed that the previously-stored platform state information 150 is still current, and system hardware is detected based on the stored state. In such case, the method 104 declines to perform a hardware probe and instead relies on the stored platform state 150 in order to detect hardware components of the platform.

From block 146 or 149, processing of the detection method 104 proceeds to block 106. At block 106, the hardware components, such as I/O apertures, chipset, memory, and the like, are initialized. Initialization 106 involves a per-device set of actions to initialize each hardware component of the platform that was detected at block 104.

Regarding I/O apertures, for example, such initialization at block 106 may include determining that I/O communication pathways (such as, e.g., a PCI bus) are responding properly. In addition, initialization 106 may include branching into option ROM to enable the options that are active in that particular system, and then branching back into the BIOS program to complete initialization. An image from the option ROM may be loaded into a memory location during the initialization 106. In addition, initialization 106 may include initializing the values of a set of configuration registers.

Regarding memory, for example, a platform may include one or more components of RAM (random access memory), such as a DIMM (dual in-line memory module). During initialization, the DIMM may be queried to determine its characteristics, such as its density, speeds, etc. Oftentimes, such DIMM initialization is a very time-consuming process because it is accomplished over a relatively slow communication pathway, such as a simple two-wire system management bus.

Other additional processing may be performed by the BIOS at block 106, such as loading any microcode patches that have been incorporated into the BIOS code. It should be noted that, at block 106, the stored platform state information 150 may be consulted during initialization in order to avoid unnecessary I/O processes. For example, enumeration of a platform's PCI subsystem and determination of the address ranges required to boot and/or talk to the specific PCI devices is a significant endeavor in terms of time and I/O bandwidth. If such information was determined during the last boot and stored with the state information 150, and if no changes have occurred since the information was stored, then such information 150 may be utilized during initialization 106 in order to avoid unnecessary I/O processes during initialization 106. Utilization of all or part of the stored platform state information 150 during initialization processing 160 is illustrated in FIG. 1 by a dotted line between the stored platform state information 150 and block 106.

At block 107, it is determined whether any additional initialization processing is required. If so, processing continues at block 106 until the platform initialization is complete. Processing then proceeds to block 110.

At block 110, BIOS processing is completed and the operating system is booted. For at least one embodiment, at block 110 the BIOS program loads the OS into main memory from a disk.

Processing proceeds from block 110 to block 130. After the OS has been booted, normal system processing continues at block 130.

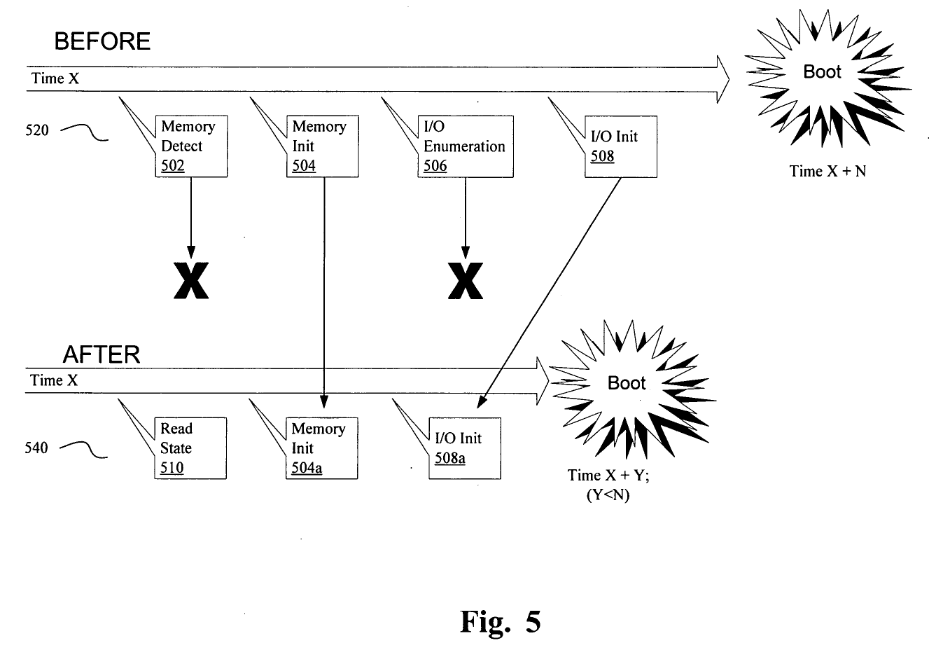

Briefly turning to FIG. 5, shown is a timing diagram illustrating that time savings may be realized during a boot process for a platform that utilizes the method 104 for hardware component detection as illustrated in FIG. 1.

FIG. 5 illustrates the time required for a first boot process 520 and a second boot process 540. The first boot process 520 represents a traditional detection, enumeration and initialization sequence that relies on probing the hardware. In contrast, the second boot process 540 represents a boot process performed according to the method 100 illustrated in FIG. 1.

FIG. 5 illustrates that the first process 520 includes all of the time required to detect the presence and characteristics of hardware memory resources of the platform 502, as well as the time required to detect the presence and characteristics of I/O devices such as a keyboard, mouse, PCI devices, hard disk drives, and the like. Assuming that the boot process 520 begins at time X, the boot process 520 completes system boot at time X+N.

In contrast, the second boot process 540 takes less time to complete, because it does not perform the memory detection 502 or I/O enumeration that are performed during the first boot process 520. Instead, the second boot process 540 reads 510 saved platform state to detect the hardware components present in the platform (see, e.g., discussion above of block 146 of FIG. 1). The second boot process does perform memory initialization 504a and I/O initialization 508a, although these actions 504a, 508a may take less time to perform than their counterparts 504, 508 that are performed during the first boot process 520. This is because, during the second boot process 540, certain information from the saved platform state (see 150 of FIG. 1) may be utilized during initialization in order to reduce the amount of I/O processes needed to obtain the information needed for initialization (see, e.g., discussion above of block 106 of FIG. 1).

The time savings shown for the second boot process 540 is represented by the illustration that the second boot process 540 only takes until time X+Y to complete, where Y<N.

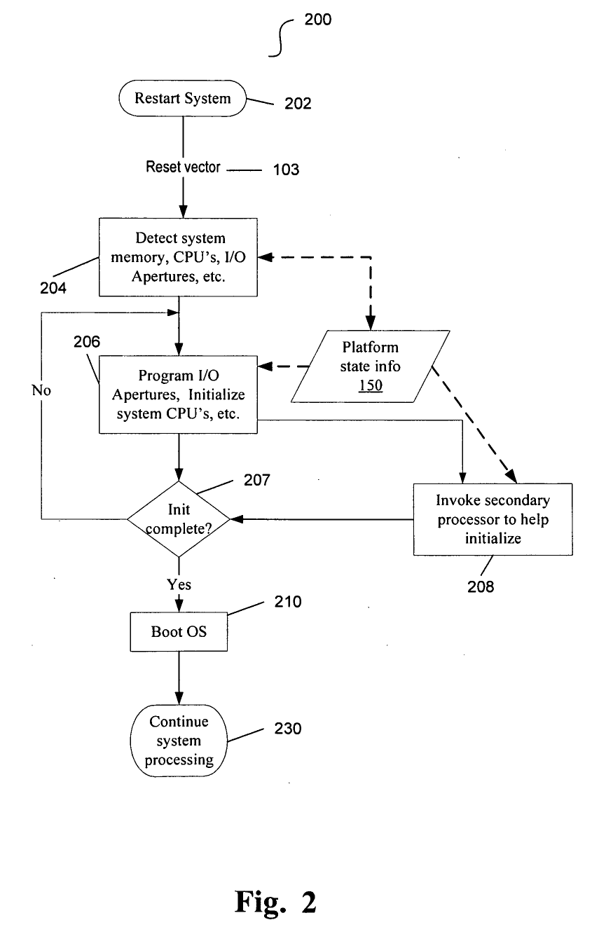

Turning now to FIG. 2, shown in a flowchart illustrating at least one embodiment of a method 200 for increasing the efficiency of initialization processing during a boot process by utilizing a secondary processor to help with the initialization. The method 200 may be performed, for at least one embodiment, by a processing system 300, 400 such as embodiments of those illustrated in FIGS. 3 and 4. The method 200 may be performed, for at least one embodiment, in conjunction with a method for more efficiently detecting hardware resources of a platform, such as an embodiment of the method 100 (in particular, portion 104) illustrated in FIG. 1.

FIG. 2 illustrates that processing for the method 200 begins at block 202, where the computer system is restarted. As is explained above in connection with FIG. 1, FIG. 2 illustrates that a reset vector 103 is dispatched responsive to a system reset event 202.

Processing proceeds from block 202 to block 204. At block 204, the hardware components of the platform are identified. For at least one embodiment, the hardware components are identified by polling the hardware of the platform.

For at least one other embodiment, however, the hardware components are identified at block 204 by a method that utilizes stored platform state instead of hardware polling, such as the method 104 illustrated in FIG. 1. This embodiment of detection 204 utilizes the stored platform state information 150 to detect hardware components of the platform.

From block 204, processing proceeds to block 206. At block 206, the processor on which the BIOS code is running may perform initialization along the lines described above in connection with block 106 of FIG. 1. However, FIG. 2 illustrates that the processor also invokes a secondary processor to perform some of the initialization tasks, concurrent with its own initialization processing at block 206.

The initialization processing 206, may involve time-consuming hand-shaking, which involves waiting for an acknowledge message from the device for each initialization message that is generated by the main CPU during the initialization. This time-intensive process may be shortened when the secondary processor performs some of this processing 208 to initialize other hardware devices in parallel with the main CPU.

The initialization processing 206 of the main processor as well as the initialization processing 208 of the secondary processor may be made more efficient by utilizing the stored information 208 to determine the characteristics of the hardware components [these characteristics would otherwise be determined during relatively time-consuming I/O processing].

Again, for the particular embodiment of hardware resource initialization 206, 208 illustrated in FIG. 2, it is assumed that previous platform state information 150 is available in a non-volatile storage device, although one of skill in the art will recognize that the embodiment 104 may be modified to accommodate other manners of providing platform state information (e.g., out-of-band inputs or local override).

At block 207, it is determined whether any additional initialization processing is required. If so, processing continues at block 206 until the platform initialization is complete. Processing then proceeds to block 110. On successive loop iterations, block 206 may again invoke the secondary processor at block 208 in order to perform additional initialization tasks.

Whether to invoke the secondary processor at block 208, and which processes should be performed by the secondary processor, may be determined by the main processor according to a platform policy. For example, a simple round-robin approach may be utilized to assign which initialization tasks are to be off-loaded to the secondary processor. For such embodiments, the offloading of additional initialization tasks to the secondary processor on successive iterations of block 206 simply check to see if the secondary processor has completed its previous initialization task and, if so, a next task is assigned to be performed at block 208, simply according to the round-robin approach. Of course, one of skill in the art will recognize that other, more sophisticated offload policies may be implemented in order to drive the decision of which initialization tasks to offload to the secondary processor, such that particular tasks are assigned to the secondary processor based on factors such as bandwidth required for the task, type of device to be initialized, and the like.

If it is determined at block 207 that the initialization processing for the platform is complete, then processing proceeds to block 210. At block 210, the operating system is booted, and then processing proceeds to block 230, where normal system processing proceeds.

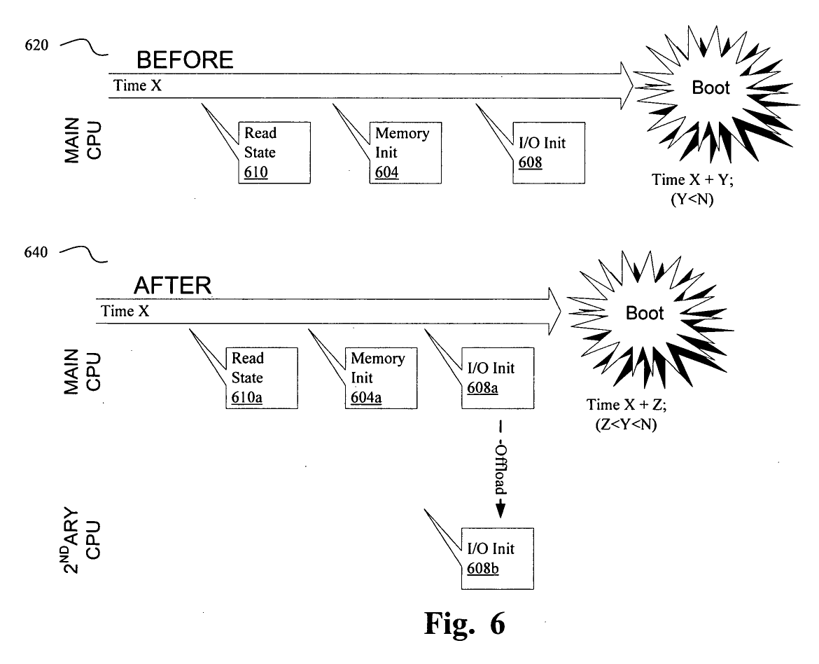

Brief reference to FIG. 6, which is a timing diagram, illustrates that the time it takes to initialize a platform may be reduced when the method 200 of FIG. 2 is practiced. FIG. 6 illustrates that, even if the boot process has been shortened by utilizing stored platform information (see, e.g., the discussions above of FIGS. 1 and 5), additional time savings can be realized by effectively parallelizing the initialization processing via a secondary processor. One of skill in the art will recognize that the illustration of FIG. 6 should not be taken to be limiting—the method 200 of FIG. 2 may be practiced in conjunction with the method 100 of FIG. 1 as shown in FIG. 6, or the method 200 may be practiced with a traditional detection scheme that does not incorporate the processing 104 shown in FIG. 1.

Thus, FIG. 6 is a timing diagram illustrating that time savings may be realized during a boot process for a platform that utilizes the method 200 for hardware component initialization as illustrated in FIG. 2.

FIG. 6 illustrates the time required for a first boot process 620 and a second boot process 640. The first boot process 620 includes a traditional initialization sequence that relies on the main CPU to perform all of the initialization processing for the memory 610 and for the I/O apertures 604. In contrast, the second boot process 640 represents a boot process performed according to the method 200 illustrated in FIG. 2, where certain initialization processing is offloaded to a secondary processor.

FIG. 6 illustrates that the first process 620 requires the time (X+Y) to perform memory initialization 604 and I/O initialization 608 with a single CPU. Although FIG. 6 illustrates that the first boot process 620 includes reading of the saved platform state 150 (see FIG. 2) at block 610, one of skill in the art will recognize that this utilization of saved platform state is optional to the processing 620.

FIG. 6 illustrates that, for the second process 640, the main CPU performs memory initialization processing 610a, but offloads a portion of the I/O initialization processing. That is, the main CPU performs part of the initialization processing 608a, but offloads a portion of the processing 608b to a secondary processor. The time savings shown for the second boot process 640 is represented by the illustration that the second boot process 640 only takes until time X+Z to complete, where Z is less than X, and Z is also less than N (see FIG. 5).

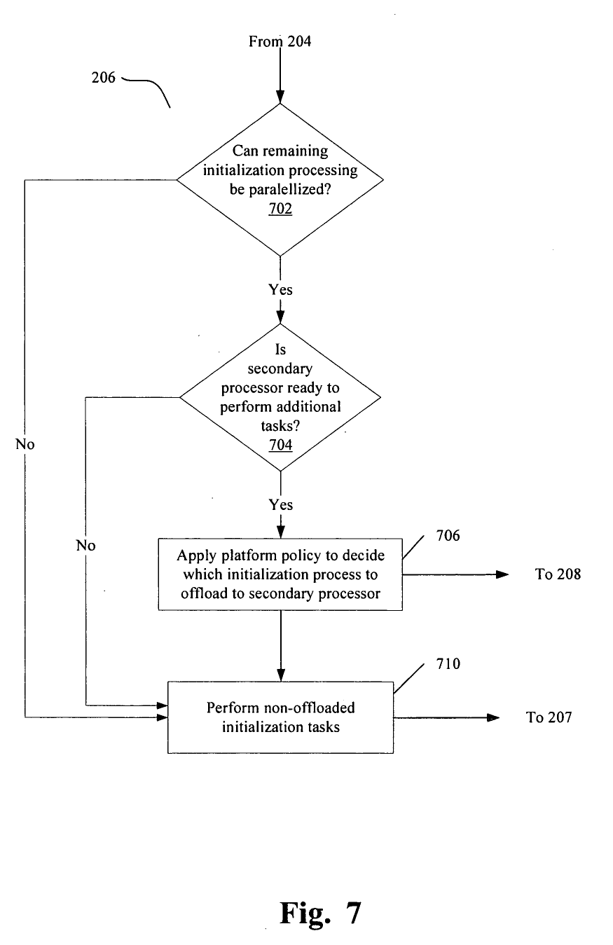

FIG. 7 is a flowchart illustrating at least one sample embodiment of processing that may be performed by a main CPU in order to determine whether to offload processing 608b to a secondary processor. Such method 700 may be performed, for at least one embodiment, by a main CPU during the initialization processing 206 illustrated in FIG. 2.

FIG. 7 illustrates that processing proceeds from block 204 of FIG. 2 to block 702 of FIG. 7. At block 702, the main CPU determines whether any of the remaining initialization tasks are amenable to parallelization and are therefore candidates to be offloaded to the secondary processor. If so, processing proceeds to block 704. Otherwise, processing proceeds to block 710 where the main CPU performs the next initialization task. Processing proceeds from block 710 to block 207 of FIG. 2.

At block 704, the main CPU determines whether the secondary processor is available to perform initialization tasks. If not, processing proceeds to block 710, where the main CPU performs the next initialization task.

Otherwise, if there are additional tasks that may be offloaded and the secondary processor is available to perform them, then processing proceeds to block 706. At block 706, the main CPU applies the platform policy, discussed above, to determine which initialization task should be offloaded to the secondary processor. Processing then proceeds to block 208 of FIG. 2, where the main CPU invokes the secondary processor to perform the initialization task that was selected at bock 706.

FIG. 3 is a block diagram of a first embodiment of a system 300 capable of performing disclosed techniques. The system 300 may include one or more processors 370, 380, which are coupled to a north bridge 390, and may also include a secondary processor 800. The optional nature of additional processors 380 is denoted in FIG. 3 with broken lines.

The north bridge 390 may be a chipset, or a portion of a chipset. The north bridge 390 may communicate with the processor(s) 370, 380 and control interaction between the processor(s) 370, 380 and memory 332. The north bridge 390 may also control interaction between the processor(s) 370, 380 and Accelerated Graphics Port (AGP) activities. For at least one embodiment, the north bridge 390 communicates with the processor(s) 370, 380 via a multi-drop bus, such as a frontside bus (FSB) 395.

FIG. 3 illustrates that the north bridge 390 may be coupled to another chipset, or portion of a chipset, referred to as a south bridge 318. For at least one embodiment, the south bridge 318 handles the input/output (I/O) functions of the system 300, controlling interaction with input/output components. Various devices may be coupled to the south bridge 318, including, for example, a keyboard and/or mouse 322, communication devices 326, and an audio I/O as well as other I/O devices 314.

Further, flash memory 351 may be coupled to the south bridge 318. The flash memory 351 may include code BIOS code 355, in one embodiment. The flash memory 351, which is non-volatile memory, may also include, for at least one embodiment, the storage location 155 to store platform state information 150 as discussed above with reference to FIGS. 1 and 2.

FIG. 3 illustrates that at least one embodiment of a secondary processor 800 that may be utilized to perform offloaded initialization processing during boot-up may reside in the north bridge 390. Such embodiment is, of course, just one of many embodiments. In other embodiments, for example, the secondary processor 800 may be stand-alone processor that is not incorporated into the north bridge 390, or may be incorporated into a different element of the system.

For at least one embodiment, the secondary processor 800 may be a processor utilized to execute firmware that implements an Intel® Management Engine. As such, the processor 800 may part of a system 300 that implements the functionality of Intel® Active Management Technology (“Intel® AMT”). For such embodiment, the communication devices 326 of the system 300 may include a network connection, such as the Intel® 82566DM Gigabit Network Connection. This network connection identifies out-of-band network traffic (traffic targeted to Intel® AMT), and routes it to the secondary processor 800 rather than to the main processor(s) 370, 380. Thus, the network connection may be coupled to the secondary processor 800.

Embodiments may be implemented in many different system types. Referring now to FIG. 4, shown is a block diagram of a multiprocessor system in accordance with an embodiment of the present invention. As shown in FIG. 4, the multiprocessor system is a point-to-point interconnect system, and includes a first processor 470 and a second processor 480 coupled via a point-to-point interconnect 450. As shown in FIG. 4, each of processors 470 and 480 may be multicore processors, including first and second processor cores (i.e., processor cores 474a and 474b and processor cores 484a and 484b). While not shown for ease of illustration, first processor 470 and second processor 480 (and more specifically the cores therein) may include patch prevention logic in accordance with an embodiment of the present invention (see 200 of FIG. 2).

Rather having a north bridge and south bridge as shown above in connection with FIG. 3, the system 400 shown in FIG. 4 may instead have a hub architecture. The hub architecture may include an integrated memory controller hub Memory Controller Hub (MCH) 472, 482 integrated into each processor 470, 480. A chipset 490 (also sometimes referred to as an Interface Controller Hub, “IHC”) may provide control of Graphics and AGP.

Thus, the first processor 470 further includes a memory controller hub (MCH) 472 and point-to-point (P-P) interfaces 476 and 478. Similarly, second processor 480 includes a MCH 482 and P-P interfaces 486 and 488. As shown in FIG. 4, MCH's 472 and 482 couple the processors to respective memories, namely a memory 432 and a memory 434, which may be portions of main memory locally attached to the respective processors.

While shown in FIG. 4 as being integrated into the processors 470, 480, the memory controller hubs 472, 482 need not necessarily be so integrated. For at least one alternative embodiment, the logic of the MCH's 472 and 482 may be external to the processors 470, 480, respectively. For such embodiment one or more memory controllers, embodying the logic of the MCH's 472 and 482, may be coupled between the processors 470, 480 and the memories 432, 434, respectively. For such embodiment, for example, the memory controller(s) may be stand-alone logic, or may be incorporated into the chipset 490.

First processor 470 and second processor 480 may be coupled to the chipset, or ICH, 490 via P-P interconnects 452 and 454, respectively. As shown in FIG. 4, chipset 490 includes P-P interfaces 494 and 498. Furthermore, chipset 490 includes an interface 492 to couple chipset 490 with a high performance graphics engine 438. In one embodiment, an Advanced Graphics Port (AGP) bus 439 may be used to couple graphics engine 438 to chipset 490. AGP bus 439 may conform to the Accelerated Graphics Port Interface Specification, Revision 2.0, published May 4, 1998, by Intel Corporation, Santa Clara, Calif. Alternately, a point-to-point interconnect 439 may couple these components.

For at least one embodiment, the chipset 490 may include a secondary processor 800 that may be utilized to perform offloaded initialization processing in accordance with at least one embodiment of the method 200 illustrated in FIG. 2. For at least one embodiment, for example, the secondary processor 800 may be a processor utilized to execute firmware that implements an Intel® Management Engine. As such, the processor 800 may part of a system 300 that implements the functionality of Intel® Active Management Technology (“Intel® AMT”). For such embodiment, the communication devices 426 of the system 300 may include a network connection, such as the Intel® 82566DM Gigabit Network Connection. This network connection identifies out-of-band network traffic (traffic targeted to Intel® AMT), and routes it to the secondary processor 800 rather than to the main processor(s) 470, 480. One of skill in the art will recognize that, in alternative embodiments, the secondary processor 800 may be a stand-alone processor, or may be incorporated into some other component of the system 400 instead of in the chipset 490.

In turn, chipset 490 may be coupled to a first bus 416 via an interface 496. In one embodiment, first bus 416 may be a Peripheral Component Interconnect (PCI) bus, as defined by the PCI Local Bus Specification, Production Version, Revision 2.1, dated June 1995 or a bus such as the PCI Express bus or another third generation input/output (I/O) interconnect bus, although the scope of the present invention is not so limited.

As shown in FIG. 4, various I/O devices 414 may be coupled to first bus 416, along with a non-volatile cache 350, such as a flash memory. The non-volatile cache 350 may include a storage area 155 to store platform state information 150 as discussed above with reference to FIGS. 1 and 2.

A bus bridge 418 may couple first bus 416 to a second bus 420. In one embodiment, second bus 420 may be a low pin count (LPC) bus.

Various devices may be coupled to second bus 420 including, for example, a keyboard/mouse 422, communication devices 426 and a data storage unit 428 which may include code 430, in one embodiment. Further, an audio I/O 424 may be coupled to second bus 420. Note that other architectures are possible. For example, instead of the point-to-point architecture of FIG. 4, a system may implement a multi-drop bus or another such architecture.

As is stated above, although illustrated in FIG. 3 as being part of the north bridge 390, and illustrated in FIG. 4 as being part of the chipset 490, the secondary processor 800 may instead reside in other portions of the systems 300, 400 without departing from the scope of the appended claims. For example, the secondary processor 800 may, instead, be a standalone processor (not shown), may reside in the south bridge 319, or may reside in any other location of the system 300, 400 either incorporated into another portion of the system, or as a standalone processor.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code may be applied to input data to perform the functions described herein and generate output information. Accordingly, alternative embodiments of the invention also include machine-accessible media containing instructions for performing the operations of the invention or containing design data, such as HDL, that defines structures, circuits, apparatuses, processors and/or system features described herein. Such embodiments may also be referred to as program products.

Such machine-accessible media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language

While particular embodiments of the present invention have been shown and described, it will be obvious to those skilled in the art that changes and modifications can be made without departing from the scope of the appended claims. For example, the foregoing mechanism for preventing post-boot updates of microcode may be equally applicable, in other embodiments, to updates of other types of code rather than being limited to microcode stored in flash memory. For one such alternative embodiment, for example, the mechanisms and methods described herein may be utilized to prevent post-boot loading of other types of code patches, including macro-code or a collection of instructions encoded in the main instruction set.

Accordingly, one of skill in the art will recognize that changes and modifications can be made without departing from the present invention in its broader aspects. The appended claims are to encompass within their scope all such changes and modifications that fall within the true scope of the present invention.

What is claimed is:

1. A system, comprising:
a processor;
system hardware resources coupled to the processor; and
a memory coupled to the processor, said memory to store a saved state that identifies system hardware resources;
said processor further comprising a boot logic module to utilize the saved platform state in order to detect during boot processing, without querying the system hardware resources, the presence of the system hardware resources.

2. The system of claim 1, wherein:
said memory is a flash RAM.

3. The system of claim 1, further comprising:
a DRAM memory module.

4. The system of claim 1, wherein:
said boot logic module further comprises a logic module to initialize a first subset of the system hardware resources during boot processing;
said boot logic module further to invoke a secondary processor to initialize a second subset of the system hardware resources during said boot processing.

5. The system of claim 4, wherein:
said system further comprises a chipset; and
said secondary processor is part of said chipset.

6. The system of claim 1, further comprising:
a memory location dedicated to maintain a value to indicate a potential change to the hardware system resources since the state was saved.

7. The system of claim 1, wherein:
said boot logic module is to utilize the saved platform state responsive to determining that the system hardware resources have not changed since the state was saved.

8. The system of claim 1, wherein:
said logic is further to utilize the saved platform state responsive to determining that the hardware system resources have not changed since the state was saved.

9. The system of claim 1, wherein:
said boot logic module is further to query, responsive to determining a potential change in the hardware system resources since the state was saved, the system hardware resources during boot processing to detect the presence of the system hardware resources.

10. The system of claim 4, wherein:
said boot logic module is to select said second subset based on an offload policy.

11. The system of claim 10, wherein:
said offload policy is a round-robin policy between said processor and said secondary processor.

12. The system of claim 4, further comprising:
a network connection to support out-of-band communication with the secondary processor.

13. A method comprising:
querying a saved platform state to determine the presence of a set of computer resources on a computing platform without querying the individual computer resources;
signaling, by a first processor, to a second processor to begin initialization of a second subset of the computer resources; and
initializing, by the first processor, a first subset of the computer resources concurrently with the initialization of the second subset.

14. The method of claim 13, further comprising:
determining whether the set of computer resources has changed since the platform state was saved and, if so, querying the individual computer resources to determine the current platform state.

15. The method of claim 14, further comprising:
saving the current platform state.

16. An article comprising:
a tangible storage medium having a plurality of machine accessible instructions;
wherein, when the instructions are executed by a processor, the instructions provide for:
querying a saved platform state to determine the presence of a set of computer resources on a computing platform without querying the individual computer resources;
signaling, by a first processor, a second processor to begin initialization of a second subset of the computer resources; and
initializing, by the first processor, a first subset of the computer resources concurrently with the initialization of the second subset.

17. The article of claim 16, wherein said instructions further provide for:
determining whether the set of computer resources has changed since the platform state was saved and, if so, querying the individual computer resources to determine the current platform state.

18. The article of claim 16, wherein said instructions further provide for:
saving the current platform state.

19. A system, comprising:
a processor;
a secondary processor;
system hardware resources coupled to the processor; and
a boot logic module to initialize a first subset of the system hardware resources during boot processing; and
said boot logic module further to invoke the secondary processor to initialize a second subset of the system hardware resources during said boot processing.

20. The system of claim 19, further comprising:
a network connection to provide out-of-band communication to the secondary processor.

21. The system of claim 20, further comprising:
a memory to store platform state information received via said out-of-band communication.
